(19) United States
(12) Patent Application Publication
(10) Pub. No.: US 2026/0366232 A1
(43) Pub. Date: Nov. 19, 2026

(54) PRINTED TEXTILE

(71) Applicant: KYOCERA CORPORATION, Kyoto-shi, Kyoto (JP)

(72) Inventor: Jun HIOKI, Muko-shi, Kyoto (JP)

(21) Appl. No.: 19/488,068

(22) PCT Filed: Jun. 5, 2024
(86) PCT No.: PCT/JP2024/020562

§ 371 Date: Nov. 26, 2025

(30) Foreign Application Priority Data
Jun. 6, 2023 (JP) 2023-093424
Dec. 27, 2023 (WO) PCT/JP2023/046879

(51) Int. Cl. D06P 5/08; C09D 11/102; D06P 3/24; D06P 3/40; D06P 3/52; D06P 3/60; D06P 5/30

(52) U.S. Cl. CPC D06P 5/08; C09D 11/102; D06P 3/24; D06P 3/40; D06P 3/52; D06P 3/60; D06P 5/30

(57) ABSTRACT

A printed textile includes a printing substrate and a treatment agent deposited on the printing substrate. The treatment agent contains a pigment, binder resin particles, and a silicone component. The silicone component is on a front surface and a rear surface of the printed textile. An amount of the silicone component on the rear surface is smaller than an amount of the silicone component on the front surface.

### TECHNICAL FIELD

The present disclosure relates to a printed textile including a printing substrate and a treatment agent containing a pigment, binder resin particles, and a silicone component deposited on the printing substrate.

### BACKGROUND OF INVENTION

An inkjet textile printing method uses, for example, ink containing a pigment. The ink containing a pigment may be used with a post-treatment liquid to improve rubbing fastness of a printing substrate on which an image is formed (hereafter, may be referred to as a printed textile).

For example, Patent Literature 1 describes a method for performing inkjet recording on a low-absorption or non-absorption recording medium using a colored ink composition containing a color material, a clear ink composition containing a resin (corresponding to the post-treatment liquid), and a treatment liquid containing an aggregating agent that aggregates the components of the colored ink composition. The resin contained in the clear ink composition (corresponding to the post-treatment liquid) can protect the image to increase the wear resistance of the image, as described in Patent Literature 1.

### CITATION LIST

### Patent Literature

Patent Literature 1: Japanese Unexamined Patent Application Publication No. 2019-147307

### SUMMARY

In a first aspect of the present disclosure, a printed textile includes a printing substrate and a treatment agent deposited on the printing substrate. The treatment agent contains a pigment, binder resin particles, and a silicone component. The silicone component is on a front surface and a rear surface of the printed textile. An amount of the silicone component on the rear surface is smaller than an amount of the silicone component on the front surface.

### BRIEF DESCRIPTION OF THE DRAWINGS

FIG. 1 is a schematic cross-sectional view of a printed textile according to an embodiment of the present disclosure, illustrating an example structure.

FIG. 2 is a partial side view of an inkjet textile printing apparatus used for producing the printed textile according to the embodiment of the present disclosure, illustrating an example structure.

FIG. 3 is a perspective view of an inkjet printer used for producing the printed textile according to the embodiment of the present disclosure, illustrating an example overall structure.

FIG. 4 is a schematic cross-sectional view taken along line II-II in FIG. 3.

FIG. 5 is an enlarged perspective view of a carriage illustrated in FIG. 3.

### DESCRIPTION OF EMBODIMENTS

Nowadays, inkjet textile printing techniques are requested to achieve improved rubbing fastness of printed textiles. The rubbing fastness of a printed textile can be improved by treating the printing substrate with a post-treatment liquid containing silicone oil. More specifically, silicone oil reduces friction. The printed textile thus can achieve improved rubbing fastness by coating the image formed on a printing substrate with silicon oil.

However, the rubbing fastness of a printed textile can change based on various factors including the type of silicone oil contained in the post-treatment liquid, the concentration of the silicone oil, the particle diameter of emulsified silicone oil, and an ejected amount (total ejected amount) of the post-treatment liquid. The conditions for a printed textile with intended rubbing fastness may be determined based on the structure of the printed textile obtained after the printing substrate is treated with the post-treatment liquid. Note that Patent Literature 1 does not describe the relationship between the structure and the wear resistance of the printed textile obtained after the printing substrate is treated with a clear ink composition (corresponding to the post-treatment liquid).

An inkjet textile printing method uses, in addition to the ink containing a pigment, a pretreatment liquid as intended for, for example, vibrant color development. However, once an image is formed on the printing substrate using the pretreatment liquid and the ink, the texture (e.g., fabric hand and feel) of the printed textile deteriorates as compared with the texture before image formation. Thus, a printed textile with intended texture and rubbing fastness is to be produced.

The printed textile according to one or more embodiments of the present disclosure has intended texture and rubbing fastness.

In one or more embodiments of the present disclosure, “a printed textile including a printing substrate and a treatment agent containing a pigment, binder resin particles, and a silicone component deposited on the printing substrate” refers to a printed textile obtained by ejecting, delivering, or applying ink containing a pigment and binder resin particles and a post-treatment liquid containing silicone oil, which is a silicone component, in this order onto an intended image formation area on a printing substrate using any method known to those skilled in the art, such as inkjet printing, spray printing, or dip coating, and heating and drying the printed textile as appropriate. Note that the printing substrate may be treated with the pretreatment liquid before the ink is ejected, delivered, or applied. More specifically, in one or more embodiments of the present disclosure, a “treatment agent” does not selectively refer to one of the ink or the post-treatment liquid (or one of the pretreatment liquid, the ink, or the post-treatment liquid). In one or more embodiments of the present disclosure, the “treatment agent” refers to a group of treatment components that remains in the ink and the post-treatment liquid (or the pretreatment liquid, the ink, and the post-treatment liquid) after the printed textile is produced without volatilizing through, for example, heating.

In one or more embodiments of the present disclosure, a “printing substrate” may be any fabric including woven fabric or knitted fabric. Examples of the printing substrate include, for example, fabrics of cotton, silk, hemp, polyester, acetate, rayon, nylon, and polyurethane. The printing substrate may be polyester fabric among the fabrics described above.

In one or more embodiments of the present disclosure, a “silicone component” refers to a polymer having a siloxane bond as the skeleton and having an organic group mainly consisting of a methyl group bonded to the silicon in the skeleton. More specifically, the “silicone component” refers to a component that is derived from silicone oil contained in the post-treatment liquid and remains in a form changed by, for example, heating and drying after a post-treatment.

In one or more embodiments of the present disclosure, an “amount of the silicone component” can be based on Si detection amount (mass %) measured by quantitative analysis using energy-dispersive X-ray spectroscopy (hereafter also referred to as EDX). More specifically, the amounts of silicone component can be compared by comparing the Si detection amounts. In one or more embodiments of the present disclosure, a ratio of the amounts of silicone component can also be determined based on the Si detection amounts. In other words, the ratio of the amounts of silicone components (%) refers to the ratio of the Si detection amounts (%).

Embodiments of the present disclosure will now be described in detail with reference to the drawings. Note that the scope of the present disclosure is not limited to the embodiments described below and may be changed in various manners without departing from the spirit and scope of the present disclosure.

### 1. Printed Textile

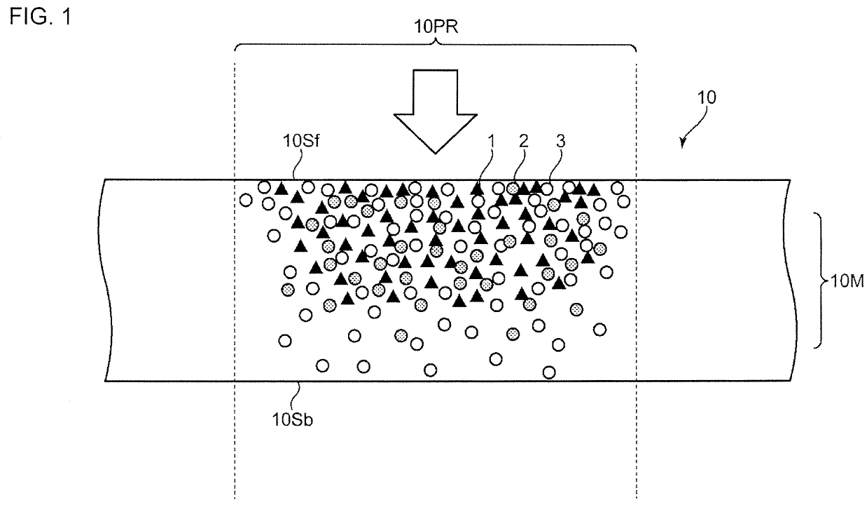

The structure of the printed textile according to the present embodiment will now be described with reference to the drawings. FIG. 1 is a schematic cross-sectional view of the printed textile according to an embodiment of the present disclosure, illustrating an example structure. As illustrated in FIG. 1, a printed textile 10 has an image formation area 10PR on which a treatment agent containing a pigment 1, binder resin particles 2, and a silicone component 3 (a group of treatment components remaining in the ink and the post-treatment liquid or in the pretreatment liquid, the ink, and the post-treatment liquid, after the printed textile is produced) is deposited. The pigment 1 and the binder resin particles 2 are components derived from the ink. The silicone component 3 is derived from the silicone oil contained in the post-treatment liquid. Note that the ink and the post-treatment liquid containing the silicone oil will be described in detail later in “2. Method for Producing Printed Textile.” The image formed on the printed textile 10 can be viewed in the direction of the arrow in FIG. 1.

As illustrated in FIG. 1, the silicone component 3 is on a front surface 10Sf and a rear surface 10Sb of the printed textile in the image formation area 10PR.

In one or more embodiments of the present disclosure, the “front surface of the printed textile” refers to a surface of the image formation area of the printed textile onto which the ink and the post-treatment liquid (or the pretreatment liquid, the ink, and the post-treatment liquid) are, for example, ejected. Note that the “front surface of the printed textile” refers to, when the Si detection amount is measured by quantitative analysis using the EDX, an area near the front surface of the printed textile measured under the conditions described later in detail with reference to working examples. The “rear surface of the printed textile” refers to a surface opposite to the surface of the image formation area of the printed textile onto which the ink and the post-treatment liquid (or the pretreatment liquid, the ink, and the post-treatment liquid) are, for example, ejected. In the same or a similar manner, when the Si detection amount is measured by quantitative analysis using the EDX, the “rear surface of the printed textile” refers to an area near the rear surface of the printed textile measured under the conditions described later in detail with reference to the working examples. In one or more embodiments of the present disclosure, an “inner layer portion between the front surface and the rear surface of the printed textile” refers to an inner portion of the printed textile between these surfaces.

In one or more embodiments of the present disclosure, “the silicone component is on the front surface (or the rear surface) of the printed textile” indicates that Si is detected on the front surface (or the rear surface) of the printed textile with quantitative analysis using the EDX, as described later in detail with reference to the working examples.

In the present embodiment, the amount of the silicone component 3 in the printed textile 10 is smaller on the rear surface 10Sb than on the front surface 10Sf of the printed textile, as illustrated in FIG. 1. The printed textile 10 having the permeation gradient of the amount of the silicone component 3 decreasing from the front surface toward the rear surface of the printed textile 10 has intended texture and rubbing fastness. More specifically, the silicone component 3 permeating through the printed textile from the front surface to the rear surface can improve the texture and friction resistance of the printed textile. With a small amount of the silicone component 3 on the rear surface and a sufficient amount of the silicone component 3 on the front surface, the front of the printed textile 10 on which the image is formed can have improved rubbing fastness. A small amount of the silicone component 3 on the rear surface can also effectively retain the absorbency of the rear surface of the printed textile 10. However, an excessively small amount of the silicone component 3 on the rear surface can degrade the texture of the printed textile 10.

The amount of the silicone component 3 on the rear surface 10Sb of the printed textile may be less than or equal to 70% of the amount of the silicone component 3 on the front surface 10Sf of the printed textile. When the amount of the silicon component 3 is less than or equal to 70%, the printed textile 10 can have more intended rubbing fastness, or specifically, more intended wet rubbing fastness. The lower limit of the amount of the silicone component 3 on the rear surface 10Sb of the printed textile may be, but not limited to, greater than 15% of the amount of the silicone component 3 on the front surface 10Sf of the printed textile. When the amount of the silicone component 3 on the rear surface 10Sb is greater than 15% of the amount of the silicone component 3 on the front surface 10Sf of the printed textile, the printed textile 10 reliably has intended texture. Note that printing substrates of different types have different levels of texture (e.g., fabric hand or feel). Thus, the level of the texture of the printed textile 10 having the amount of the silicone component 3 on the rear surface 10Sb greater than 15% of the amount of the silicone component 3 on the front surface 10Sf can vary based on the type of printing substrate.

The amount of the silicone component 3 on the rear surface 10Sb may be less than or equal to 68%, specifically less than or equal to 66%, or more specifically less than or equal to a value selected from the group consisting of 65%, 63%, 62%, 60%, 58%, 56%, 54%, 52%, 50%, 49%, and 48% of the amount of the silicone component 3 on the front surface 10Sf of the printed textile. The amount of the silicone component 3 on the rear surface 10Sb may be greater than or equal to 20%, specifically greater than or equal to 23%, or more specifically greater than or equal to a value selected from the group consisting of 25%, 27%, 30%, 31%, 32%, 33%, 34%, 37%, 39%, 41%, 44%, and 46% of the amount of the silicone component 3 on the front surface 10Sf of the printed textile. A specific range of the amount of the silicone component 3 on the rear surface 10Sb may be 31 to 60% inclusive, specifically 33 to 60% inclusive, or more specifically 46 to 60% inclusive of the amount of the silicone component 3 on the front surface 10Sf of the printed textile. Such ranges allow the printed textile to more reliably have intended texture and rubbing fastness (particularly, appropriate wet rubbing fastness).

In the present embodiment, the pigment 1 in the printed textile 10 may be on the front surface 10Sf and in an inner layer portion 10M of the printed textile between the front surface 10Sf and the rear surface 10Sb of the printed textile, as illustrated in FIG. 1.

In one or more embodiments of the present disclosure, “the pigment is (or is not) on the front surface and in the inner layer portion between the front surface and the rear surface of the printed textile” indicates that the pigment is visually identified (or not identified) on the front surface and in the inner layer portion of the printed textile with observation of the cross section of the image formation area of the printed textile using an optical microscope as described later in detail with reference to the working examples.

When the pigment 1 is on the front surface 10Sf and in the inner layer portion 10M of the printed textile, the image formed on the printed textile 10 has vibrant colors.

In the present embodiment, the rear surface 10Sb of the printed textile 10 may be free of the pigment 1, as illustrated in FIG. 1. When the rear surface 10Sb of the printed textile is free of the pigment 1, the image on the printed textile 10 has more vibrant colors. In this case, the rear portion of the printed textile 10 can have more intended texture. In the present embodiment, the image formation area 10PR in the printed textile 10 may include the silicone component 3 in the area of the rear surface 10Sb facing the area of the front surface 10Sf of the printed textile containing the pigment, as illustrated in FIG. 1. In other words, although the ink (pigment 1) is restricted from permeating into the area near the rear surface of the printed textile, the post-treatment liquid (silicone component 3) may permeate into the area near the rear surface of the printed textile through the ink in the image formation area 10PR.

The permeation gradient of the amount of the silicone component decreasing from the front surface toward the rear surface of the printed textile can be obtained by selectively performing an appropriate method for ejecting, delivering, or applying the ink and the post-treatment liquid (or the pretreatment liquid, the ink, and the post-treatment liquid). For example, inkjet printing or spray printing can be used to produce a printed textile having such a permeation gradient of the silicone component. In particular, when the ink and the post-treatment liquid (or the pretreatment liquid, the ink, and the post-treatment liquid) are ejected onto the printing substrate using wet-on-wet inkjet printing, the post-treatment liquid is ejected before the ink (or the ink and the pretreatment liquid) dries. This easily reduces permeation of the ink (pigment 1), thus allowing easy production of the printed textile having the permeation gradient of the silicone component described above.

As described later with reference to the working examples, the ratio of the amounts of the silicone component described above is not controlled by the ejected amount (total ejected amount), the delivered amount (total delivered amount), or the applied amount (total applied amount) of the post-treatment liquid alone. More specifically, the ratio of the amount of the silicone component on the rear surface to the amount of the silicone component on the front surface of the printed textile can be controlled to be within the numerical range described above by adjusting, when the printed textile is produced, the amount of the post-treatment liquid ejected, delivered, or applied per cycle and in total based on the type of printing substrate, the amount of the ink ejected per cycle and in total, an ejection interval of the ink or the post-treatment liquid, the type of pigment in the ink, the physical properties of the ink such as the content, the content of silicone oil in the post-treatment liquid, and the physical properties of the post-treatment liquid such as the viscosity, and. In the present embodiment, the printed textile may be an inkjet-printed textile produced by inkjet printing to facilitate control of the ratio of the amounts of the silicone component.

In the same or a similar manner, the printed textile with the pigment on the front surface and in the inner layer portion of the printed textile can be easily produced using inkjet printing or spray printing, particularly wet-on-wet inkjet printing. With such a printing method, the post-treatment liquid is ejected before the ink (or the ink and the pretreatment liquid) dries, thus reducing permeation of the pigment to the rear surface of the printed textile. In the same or a similar manner, pigmented portions can be precisely controlled by adjusting the amount of the ink ejected, delivered, or applied per cycle and in total based on the type of printing substrate, the type of pigment in the ink, the physical properties of the ink such as the content, the amount of the post-treatment liquid ejected, delivered, or applied per cycle and in total.

### 2. Method for Producing Printed Textile

An example method for producing the printed textile according to the present embodiment will now be described in detail.

In the present embodiment, the printed textile can be produced by ejecting, delivering, or applying the ink and the post-treatment liquid containing silicone oil in this order onto an intended image formation area using any method known to those skilled in the art, such as inkjet printing, spray printing, or dip coating. The printed textile is then heated and dried as appropriate. Note that the printing substrate may be treated with the pretreatment liquid before the ink is ejected, delivered, or applied. The pretreatment liquid used as appropriate, the ink, and the post-treatment liquid will now be described.

### Pretreatment Liquid

The pretreatment liquid used as appropriate is any pretreatment liquid known to those skilled in the art. The pretreatment liquid contains, for example, a cationic polymer, an aqueous solvent, and a component added as appropriate (e.g., a surfactant).

The pretreatment liquid is ejected, delivered, or applied onto the printing substrate before the ink is, for example, ejected. The cationic polymer contained in the pretreatment liquid reacts and aggregates with the pigment contained in the ink that is, for example ejected in the subsequent processes, reliably achieving vibrant color development (optical density or OD).

The cationic polymer contained in the pretreatment liquid is any positively charged cationic polymer. Examples of the cationic polymer include an ammonium-containing polymer, an amine-containing polymer, polyallylamine, polyvinylamine, polyimine, polyvinylpyrrolidone, polyethylenimine, polyvinylpyridine, aminoacetalized polyvinyl alcohol, an ionene polymer, polyvinyl imidazole, polyvinyl benzylphosphonium, polyalkyl allyl ammonium, polyamidine, and polyamine sulphone. To achieve more vibrant color development, the cationic polymer may include, among the polymers described above, at least one selected from the group consisting of a quaternary ammonium-containing polymer, a diallyldimethylammonium sulfur dioxide copolymer, a diallyldimethyl ammonium chloride acrylamide copolymer, a diallyldimethylammonium chloride polymer, a dimethylamine-ammonia-epichlorohydrin polycondensate, and a dimethylamine-ammonia-epichlorohydrin polycondensate.

The cationic polymer may have a weight-average molecular weight in a range of, but not limited to, about 1000 to 10000. The content of the cationic polymer relative to the total mass of the pretreatment liquid is not limited, but may be 0.3 to 35 mass % inclusive.

The aqueous solvent contained in the pretreatment liquid is not limited, but is typically water or a mixture of water and an organic solvent.

Examples of the organic solvent include, but are not limited to, glycols, alcohols, aliphatic hydrocarbons, aromatic hydrocarbons, ketones, esters, ethers, and vegetable oils. Examples of water-soluble organic solvents include polyhydric alcohols, ether compounds of polyhydric alcohols, nitrogen-containing compounds, alcohol compounds, sulfur-containing compounds, propylene carbonates, and ethylene carbonates. Of these organic solvents, glycols such as propylene glycol may be used. One of these organic solvents may be used alone, or two or more of these may be used in combination.

When the pretreatment liquid contains an organic solvent, the content of the organic solvent may be 3 mass % to 50 wt % inclusive of the total mass of the pretreatment liquid.

The pretreatment liquid may further contain a surfactant to adjust the surface tension to an appropriate level. Examples of usable surfactants include, but are not limited to, nonionic surfactants, cationic surfactants, and anionic surfactants. When the pretreatment liquid contains a surfactant, the content of the surfactant may be 0.1 to 5 mass % inclusive relative to the total mass of the pretreatment liquid.

The pretreatment liquid may contain other additives as appropriate. Examples of the other additives include dissolution stabilizers, anti-drying agents, antioxidants, viscosity modifiers, pH adjusters, and antifungal agents.

The pretreatment liquid may be prepared with any method known to those skilled in the art. For example, a basic ion-exchange resin is introduced into a column, through which the cationic polymer is passed to obtain a modified cationic polymer having a lower concentration of halide ions. The resulting modified cationic polymer, the aqueous solvent, and the components added as appropriate (e.g., surfactants) are mixed to obtain the pretreatment liquid.

### Ink

The ink may be any ink containing a pigment and binder resin particles and known to those skilled in the art. The ink contains, for example, a pigment, binder resin particles, and an aqueous medium. The ink may further contain at least one type of component selected from the group consisting of surfactants and polyols as appropriate. These components will now be described.

The pigment is dispersed in the aqueous medium. To obtain ink with intended OD, hue, and color stability, the pigment may have a volume median diameter (D₅₀) of 30 to 250 nm inclusive. Note that values of D₅₀ in one or more embodiments of the present disclosure are measured with a laser diffraction-scattering particle size distribution analyzer (“LA-950” manufactured by Horiba, Ltd.).

Examples of the pigment include, for example, yellow, orange, red, blue, violet, and black pigments. Examples of the yellow pigment include C.I. Pigment Yellow (74, 93, 95, 109, 110, 120, 128, 138, 139, 151, 154, 155, 173, 180, 185, and 193). Examples of the orange pigment include C.I. Pigment Orange (34, 36, 43, 61, 63, and 71). Examples of the red pigment include C.I. Pigment Red (122 and 202). Examples of the blue pigment include C.I. Pigment Blue (15, or more specifically, 15:3). Examples of the violet pigment include C.I. Pigment Violet (19, 23, and 33). Examples of the black pigment include C.I. Pigment Black (7).

The content of the pigment may be 1 to 12 mass % inclusive relative to the total mass of the ink. A pigment content greater than or equal to 1 mass % can improve the OD of the printed textile to be produced. A pigment content less than or equal to 12 mass % allows the ink to be highly fluid.

The aqueous medium in the ink mainly contains water. The aqueous medium may function as a solvent or a dispersion medium. A specific example of the aqueous medium is water or a mixture of water and a polar solvent. Examples of the polar solvent contained in the aqueous medium include methanol, ethanol, isopropyl alcohol, butanol, and methyl ethyl ketone. The content of the water in the aqueous medium may be greater than or equal to 90 mass %, or specifically 100 mass %. The content of the aqueous medium relative to the total mass of ink may be 5 to 70 mass % inclusive, or specifically 40 to 60 mass % inclusive.

The binder resin particles are dispersed in the aqueous medium. The binder resin particles function as a binder that bonds the pigment to the printing substrate. Thus, the ink containing the binder resin particles allows production of a printed textile with high fixation of the pigment.

Examples of the resin contained in the binder resin particles include polyurethane resins, (meth)acrylic resins, styrene-(meth)acrylic resins, styrene-maleic acid copolymers, vinyl naphthalene-(meth)acrylic acid copolymers, and vinyl naphthalene-maleic acid copolymers. The resin contained in the binder resin particles may be a polyurethane resin.

The content of the binder resin particles relative to the total mass of the ink may be 1 to 20 mass % inclusive. When the content of the binder resin particles is greater than or equal to 1 mass %, the printing substrate can have high fixation of the pigment. When the content of the binder resin particles is less than or equal to 20 mass %, the ink can be stably ejected onto the printing substrate.

Ink containing a surfactant has higher wettability for the printing substrate. Examples of the surfactant include anionic, cationic, nonionic, and amphoteric surfactants. The surfactant contained in the ink may be a nonionic surfactant. The nonionic surfactant may have a structure of acetylene glycol and may be an ethylene oxide adduct of acetylene diol. The surfactant may have an HLB value of 3 to 20 inclusive. The HLB value of a surfactant is calculated, for example, with Griffin's method using the formula “HLB=20×(the sum of formula weights of hydrophilic portions)/molecular weight.” To reduce offsets and improve OD of an image, the content of the surfactant relative to the mass of ink may be 0.1 to 5.0 mass % inclusive, or specifically 0.5 to 2.0 mass % inclusive.

Ink containing polyols can have its viscosity adjusted as appropriate. Examples of the polyols contained in the ink include ethylene glycol, propylene glycol, diethylene glycol, triethylene glycol, tetraethylene glycol, and glycerin.

The ink may further contain a known additive (more specifically, a dissolution stabilizer, an anti-drying agent, an antioxidant, a viscosity modifier, a pH adjuster, or an antifungal agent) as appropriate.

The ink may be prepared with any method known to those skilled in the art. For example, the ink can be prepared by mixing, with an agitator, a pigment, binder resin particles, an aqueous medium, and a component added as appropriate (e.g., surfactants and polyols). The mixing time is, for example, 1 to 30 minutes inclusive.

### Post-Treatment Liquid

The post-treatment liquid is any post-treatment liquid containing silicone oil and known to those skilled in the art. The post-treatment liquid contains, for example, emulsified particles containing silicone oil, an aqueous medium, and a component added as appropriate (e.g., acids, bases, polyols, and dispersants). The emulsified particles are dispersed in, for example, the aqueous medium of the post-treatment liquid. In other words, the post-treatment liquid is an emulsion, or more specifically, an oil-in-water (o/w) emulsion.

The average particle diameter of the emulsified particles containing silicone oil (the dispersed particle diameter in the aqueous medium) may be 100 to 250 nm inclusive. When the emulsified particles have an average particle diameter of 100 to 250 nm inclusive, the post-treatment liquid allows production of the printed textile with more intended texture and higher rubbing fastness and can be ejected easily from a treatment head of an inkjet textile printing apparatus. The average particle diameter of the emulsified particles refers to the harmonic mean particle diameter (also referred to as a cumulant average particle diameter) calculated with a cumulant method based on scattering light intensity references. The average particle diameter of the emulsified particles is measured based on the method described in ISO 13321:1996 (Particle size analysis-Photon correlation spectroscopy).

The silicone oil contained in the emulsified particles is at least one of silicone oil containing an ionic group or unmodified silicone oil. The silicone oil containing an ionic group and unmodified silicone oil will now be described.

The silicone oil containing an ionic group is modified silicone oil, or more specifically, ionic group-modified silicone oil. Examples of ionic group-modified silicone oil include modified silicone oil with an ionic group introduced to its side chain or its end group.

The modified silicone oil with an ionic group introduced to its side chain includes a first end group expressed by Formula 1a, a repeating unit expressed by Formula 1b, a repeating unit expressed by Formula 1c, and a second end group expressed by Formula 1d.

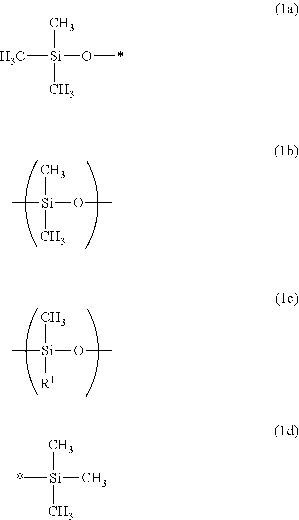

In Formula 1a, * indicates a dangling bond that bonds to a silicon atom in the repeating unit expressed by Formula 1b or 1c. In Formula 1d, * indicates a dangling bond that bonds to an oxygen atom in the repeating unit expressed by Formula 1b or 1c. In Formula 1c, R¹ represents a group containing an ionic group. The group containing an ionic group may be an amino group, a carboxy group, a phenolic hydroxy group, or a silanol group.

The modified silicone oil with an ionic group introduced to its end group includes a first end group expressed by Formula 2a, a repeating unit expressed by Formula 2b, and a second end group expressed by Formula 2c.

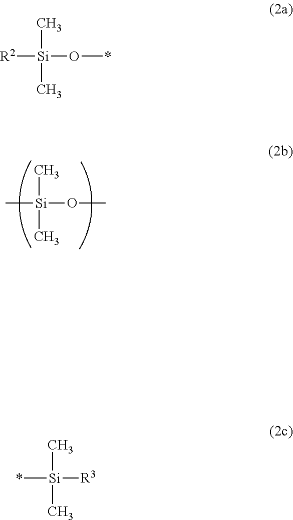

In Formula 2a, * indicates a dangling bond that bonds to a silicon atom in the repeating unit expressed by Formula 2b. In Formula 2c, * indicates a dangling bond that bonds to an oxygen atom in the repeating unit expressed by Formula 2b. In Formula 2a and Formula 2c, R² and R³ each independently represent a group containing an ionic group. The group containing an ionic group may be an amino group, a carboxy group, a phenolic hydroxy group, or a silanol group.

The silicone oil containing an ionic group may contain at least one selected from the group consisting of amino-modified silicone oil, carboxy-modified silicone oil, phenol-modified silicone oil, and silanol-modified silicone oil.

To properly disperse the emulsified particles containing silicone oil containing an ionic group in the aqueous medium, the functional group equivalent weight of the silicone oil containing an ionic group may be 1000 to 5500 g/mol inclusive. The functional group equivalent weight is the molecular weight per mol of a functional group (ionic group).

Examples of an unmodified silicone oil include dimethylpolysiloxane.

The content of the silicone oil in the post-treatment liquid may be 5 to 15 mass % inclusive. When the content of the silicone oil is greater than or equal to 5 mass %, the printed textile can be produced with intended texture and higher rubbing fastness. When the content of the silicone oil is less than or equal to 15 mass %, the post-treatment liquid can be ejected from the treatment head smoothly.

The viscosity of the silicone oil may be 500 mm²/s (mm²/second) or greater. The silicone oil with a viscosity greater than or equal to 500 mm²/s is less likely to separate from the printed textile under friction, thus allowing production of a printed textile with improved dry and wet rubbing fastness. The viscosity of silicone oil refers to the kinetic viscosity at 25 °C and is measured with the method described in JIS (Japanese Industrial Standards) Z8803:2011 (Methods for viscosity measurement of liquid). For example, the silicone oil can be extracted from the post-treatment liquid with toluene, washed, and dried to be separated from the post-treatment liquid, and the viscosity of the silicone oil can be measured.

The aqueous medium in the post-treatment liquid mainly contains water. The aqueous medium may function as a solvent or a dispersion medium. A specific example of the aqueous medium is water or a mixture of water and a polar solvent. Examples of the polar solvent contained in the aqueous medium include methanol, ethanol, isopropyl alcohol, butanol, and methyl ethyl ketone. The content of the water in the aqueous medium may be greater than or equal to 90 mass %. The content of the aqueous medium relative to the total mass of the post-treatment liquid may be 50 to 90 mass % inclusive.

The post-treatment liquid may further contain, for example, acids, bases, or polyols as appropriate.

Examples of the acids include hydrochloric acid, para-toluenesulfonic acid, and sulfuric acid as strong acids and benzoic acid and acetic acid as weak acids. Examples of the bases include sodium hydroxide.

The post-treatment liquid containing polyols can have a viscosity adjusted as appropriate. Examples of the polyols contained in the post-treatment liquid include, as with the ink described above, ethylene glycol, propylene glycol, diethylene glycol, triethylene glycol, tetraethylene glycol, and glycerin.

The post-treatment liquid may be prepared with any method known to those skilled in the art. For example, the silicone oil, the aqueous medium, and a component added as appropriate (e.g., acids or bases, and polyols) are mixed and emulsified using a homogenizer. In this manner, the emulsified particles containing the silicone oil are dispersed in the aqueous medium to obtain the post-treatment liquid.

To facilitate emulsification, a raw material emulsion containing emulsified particles may be prepared in advance and mixed with the aqueous medium and the polyols as appropriate to obtain the post-treatment liquid. The raw material emulsion contains, for example, the silicone oil, a portion of the aqueous medium, and the acid or the base added as appropriate. In preparation of the raw material emulsion, the emulsification duration is, for example, 5 minutes to 1 hour inclusive. The emulsification temperature is, for example, 5 to 40 °C inclusive. The content of the raw material emulsion relative to the total mass of the post-treatment liquid is, for example, 15 to 50 mass % inclusive.

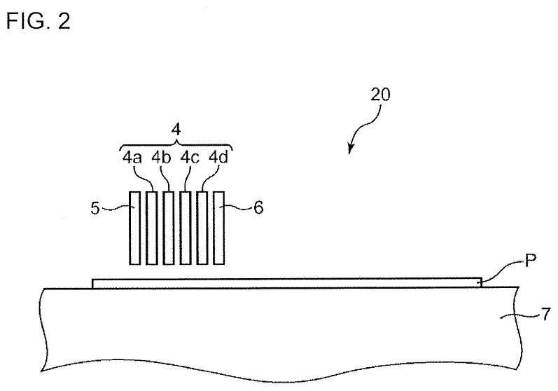

An example method for producing the printed textile according to the present embodiment using a flatbed inkjet textile printing apparatus will now be described in detail with reference to FIG. 2.

FIG. 2 is a partial side view of the inkjet textile printing apparatus used for producing the printed textile according to the embodiment of the present disclosure, illustrating an example structure. Note that FIG. 2 schematically illustrates the main components for ease of understanding. The size or the number of each illustrated component may be changed as appropriate.

A flatbed inkjet textile printing apparatus 20 (partially) illustrated in FIG. 2 ejects the pretreatment liquid, the ink, and the post-treatment liquid described above onto a printing substrate P.

The inkjet textile printing apparatus 20 illustrated in FIG. 2 includes ink heads 4, a pretreatment liquid head 5, a post-treatment liquid head 6, and a support 7. The ink heads 4 include a first ink head 4a, a second ink head 4b, a third ink head 4c, and a fourth ink head 4d.

The pretreatment liquid head 5 and the post-treatment liquid head 6 respectively eject the pretreatment liquid and the post-treatment liquid described above onto at least an image formation area on the printing substrate P. Examples of the pretreatment liquid head 5 and the post-treatment liquid head 6 include, but are not limited to, a piezoelectric head and a thermal inkjet head.

The ink heads 4 eject ink onto the image formation area on the printing substrate P. The first ink head 4a, the second ink head 4b, the third ink head 4c, and the fourth ink head 4d included in the ink heads 4 each eject a different color of ink. Examples of the ink heads 4 include, but are not limited to, a piezoelectric head and a thermal inkjet head.

The printing substrate P is placed on the support 7. The pretreatment liquid head 5, the ink heads 4, and the post-treatment liquid head 6 are arranged above the support 7 to eject the pretreatment liquid, the ink, and the post-treatment liquid onto the printing substrate P. The support 7 is driven by a motor (not illustrated) to move horizontally in a direction from the pretreatment liquid head 5 to the post-treatment liquid head 6 (e.g., to the right in FIG. 1). The support 7 moves horizontally to transport the printing substrate P on the support 7.

To produce a printed textile, the support 7 first moves horizontally to transport the printing substrate P placed on the support 7 to a position facing the pretreatment liquid head 5. The pretreatment liquid head 5 ejects the pretreatment liquid onto the printing substrate P. The pretreatment liquid head 5 may eject the pretreatment liquid onto the image formation area on the printing substrate P alone, onto an area larger than the image formation area on the printing substrate P, or onto the entire surface of the printing substrate P. A reduced amount of the pretreatment liquid causes less deterioration in the texture of the printed textile. Thus, the pretreatment liquid head 5 may eject the pretreatment liquid onto the image formation area on the printing substrate P alone.

After the pretreatment liquid is ejected from the pretreatment liquid head 5, the printing substrate P is transported to a position facing the ink heads 4. The ink heads 4 eject the ink onto the image formation area on the printing substrate P. To obtain a printed textile with the pigment on the front surface and in the inner layer portion of the printed textile, the ejected amount of the ink (the amount of the ink ejected per cycle and in total) may be adjusted as appropriate. In the same or a similar manner, to obtain a printed textile with no pigment on the rear surface of the printed textile, the ejected amount of the ink (the amount of the ink ejected per cycle and in total) may be further adjusted as appropriate. The amount of the ink ejected onto the printing substrate P (the amount of the ink ejected per cycle and in total) is adjusted as appropriate for the type of printing substrate P, the physical properties of the ink such as the type and the content of the pigment in the ink, the amount of the post-treatment liquid ejected per cycle and in total (described later), the content of the silicone oil in the post-treatment liquid, and the physical properties of the post-treatment liquid such as the viscosity of the post-treatment liquid. For example, the ejected amount of the ink (the total ejected amount) may be 5 to 40 g/m² inclusive, or specifically 10 to 40 g/m² inclusive, or more specifically 20 to 40 g/m² inclusive. In this manner, an image is formed on the image formation area on the printing substrate P with the ink. After the ink is ejected, the support 7 moves horizontally to transport the printing substrate P placed on the support 7 to a position facing the post-treatment liquid head 6.

The post-treatment liquid head 6 ejects the post-treatment liquid onto at least the image formation area on the printing substrate P. The post-treatment liquid head 6 may eject the post-treatment liquid onto the image formation area on the printing substrate P alone. The post-treatment liquid head 6 may eject the post-treatment liquid onto an area larger than the image formation area on the printing substrate P. The ejected amount of the post-treatment liquid (the amount of the post-treatment liquid ejected per cycle and in total) is appropriately adjusted to obtain a permeation gradient indicating that the amount of the silicone component decreases from the front surface toward the rear surface of the printed textile. The ejected amount of the post-treatment liquid (the amount of the post-treatment liquid ejected per cycle and in total) may be adjusted to obtain a permeation gradient indicating that the amount of the silicone component on the rear surface is less than or equal to 70% of the amount of the silicone component on the front surface. The amount of the post-treatment liquid ejected onto the printing substrate P (the amount of the post-treatment liquid ejected per cycle and in total) is adjusted as appropriate for the type of printing substrate P, the amount of the ink ejected per cycle and in total described above, the physical properties of the ink such as the type and the content of the pigment in the ink, the content of the silicone oil in the post-treatment liquid, and the physical properties of the post-treatment liquid such as the viscosity of the post-treatment liquid. For example, the ejected amount of the post-treatment liquid (the total amount of the post-treatment liquid ejected) may be greater than or equal to 2 g/m² and less than 100 g/m², specifically 3 to 60 g/m² inclusive, more specifically 4 to 45 g/m² inclusive, or more specifically 5 to 40 g/m² inclusive. In this manner, the post-treatment liquid forms a treatment film on the image formed in the image formation area on the printing substrate P.

After the post-treatment liquid is ejected from the post-treatment liquid head 6 onto the printing substrate P, the support 7 further moves horizontally to transport the printing substrate P placed on the support 7 to a position facing a heater (not illustrated). The heater heats the printing substrate P to dry the pretreatment liquid, the ink, and the post-treatment liquid. The heating temperature is, for example, 120 to 180 °C inclusive. The heating time is, for example, 1 to 10 minutes inclusive. Heating evaporates the volatile components contained in the pretreatment liquid, the ink, and the post-treatment liquid to facilitate fixation of the pretreatment liquid, the ink, and the post-treatment liquid to the printing substrate P, allowing formation of an image with the ink. This produces a printed textile including a printing substrate with a treatment agent containing the pigment, the binder resin particles, and the silicone component deposited on the printing substrate. Such a printed textile has a permeation gradient indicating that the amount of the silicone component decreases from the front surface toward the rear surface of the printed textile.

The printed textile produced in this manner has the permeation gradient of the silicone component illustrated in FIG. 1, and thus has intended texture and rubbing fastness.

The above method for producing the printed textile is a mere example, and may include variations described below.

In a first variation, the permeation gradient of the silicone component may be obtained by using, for example, a spray for delivering the post-treatment liquid, in place of the post-treatment liquid head 6 included in the inkjet textile printing apparatus 20.

In a second variation, the inkjet textile printing apparatus 20 may include no pretreatment liquid head 5, and the pretreatment liquid may not be ejected, delivered, or applied onto the printing substrate P.

In the example method for producing the printed textile describe above, the inkjet textile printing apparatus 20 includes the support 7 that moves horizontally. In a third variation, the support 7 may be stationary, and the pretreatment liquid head 5, the ink heads 4, and the post-treatment liquid head 6 may horizontally move to eject the pretreatment liquid, the ink, or the post-treatment liquid.

In a fourth variation, the printed textile according to the present embodiment may be produced using an inkjet textile printing apparatus without a flatbed.

### 3. Recording Apparatus Used to Produce Printed Textile

The overall structure of an inkjet printer (recording apparatus) that can be used to produce the printed textile according to the present disclosure will finally be described with reference to the drawings.

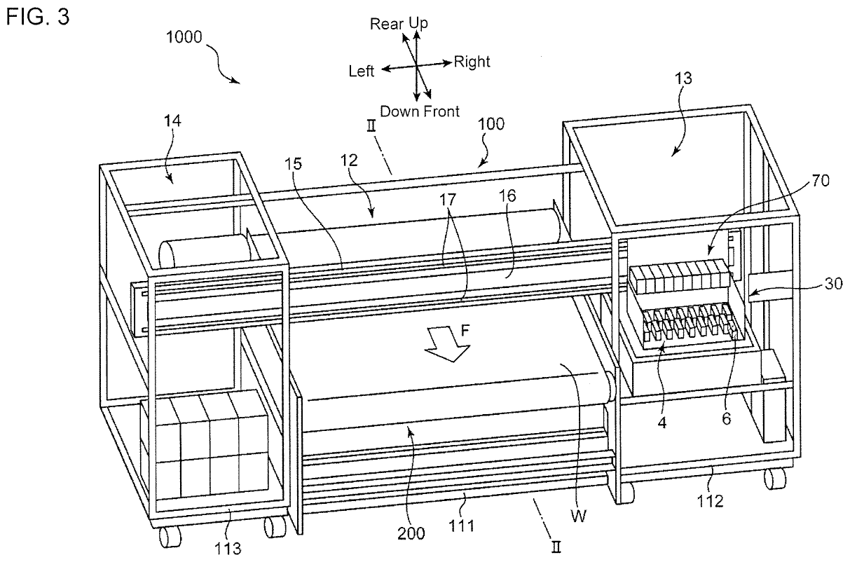

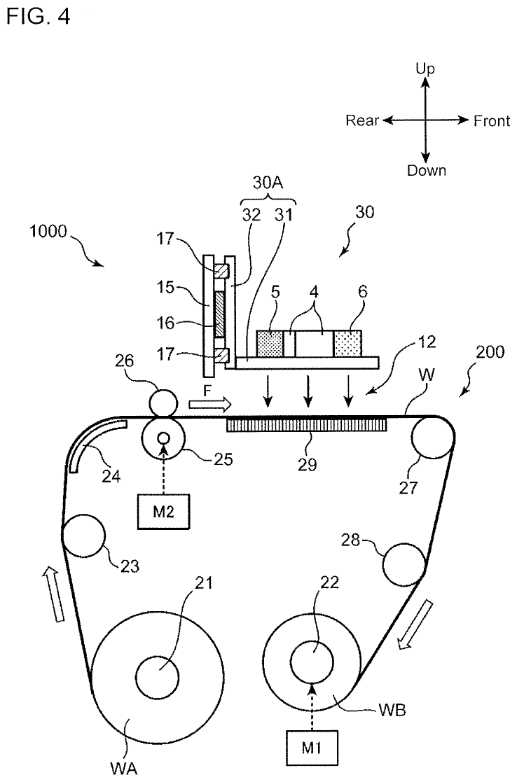

FIG. 3 is a perspective view of the inkjet printer used for producing the printed textile according to the embodiment of the present disclosure, illustrating an example overall structure. An inkjet printer 1000 illustrated in FIG. 3 may be used for digital textile printing to print, with an inkjet system, images including letters or patterns onto a printing substrate made of textile such as woven fabric or knitted fabric. The inkjet printer 1000 may also be used to print various types of images on a printing substrate such as a paper sheet or a resin sheet. FIG. 4 is a schematic cross-sectional view taken along line II-II in FIG. 3.

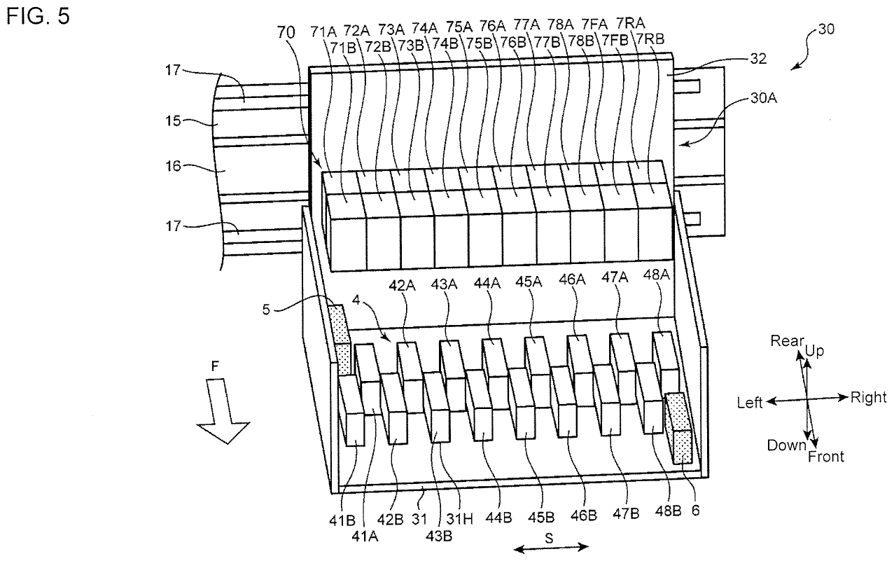

The inkjet printer 1000 prints images on a wide and elongated workpiece W (printing substrate) with an inkjet system. In one example, the workpiece W has a width of several meters. The inkjet printer 1000 includes an apparatus frame 100, and a workpiece feeder 200 and a carriage 30 incorporated in the apparatus frame 100. In the inkjet printer 1000 illustrated in FIG. 3, a lateral direction is a main scanning direction S (refer to FIG. 5) for printing on the workpiece W, and a direction from the rear to the front is a subscanning direction (a feed direction F of the workpiece W intersecting with the main scanning direction S).

The apparatus frame 100 is a frame on which various components of the inkjet printer 1000 are mounted. The workpiece feeder 200 intermittently feeds (transports) the workpiece W, moving the workpiece W in the feed direction F from the rear to the front in a printing area in which an inkjet printing process is performed. The carriage 30 carries the ink heads 4, the pretreatment liquid head 5, the post-treatment liquid head 6, and subtanks 70, and reciprocates in the main scanning direction S (lateral direction) intersecting with the feed direction F of the workpiece W during the inkjet printing process.

The apparatus frame 100 includes a center frame 111, a right frame 112, and a left frame 113. The center frame 111 is a frame on which various components of the inkjet printer 1000 are mounted and has a lateral width corresponding to the workpiece feeder 200. The right frame 112 stands on the right of the center frame 111, and the left frame 113 stands on the left of the center frame 111. A printing area 12 in which a printing process is performed on the workpiece W is defined between the right frame 112 and the left frame 113.

The right frame 112 defines a maintenance area 13. The maintenance area 13 is an area into which the carriage 30 is retracted when the printing process is not performed. In the maintenance area 13, nozzles (ejection orifices) of the ink heads 4, the pretreatment liquid head 5, and the post-treatment liquid head 6 are, for example, cleaned or purged, and are also capped. The left frame 113 defines a turn-back area 14 for the carriage 30. The turn-back area 14 is an area for the carriage 30 that has performed the main scanning of the printing area 12 from right to left to temporarily enter before performing the main scanning in the reverse direction during the printing process.

The apparatus frame 100 receives, on its upper portion, a carriage guide 15 for guiding the carriage 30 to reciprocate in the lateral direction. The carriage guide 15 is a flat plate elongated in the lateral direction and is located above the workpiece feeder 200. The carriage guide 15 receives a timing belt 16 rotatable in the lateral direction (main scanning direction). The timing belt 16 is an endless belt drivable to rotate in the left direction or the right direction.

The carriage guide 15 includes a pair of upper and lower guide rails 17 holding the carriage 30 in a manner reciprocable in the main scanning direction S. The pair of guide rails 17 extend parallel to each other in the lateral direction. The carriage 30 is engaged with the guide rails 17. The carriage 30 is fixed to the timing belt 16. In response to rotation of the timing belt 16 in the left direction or the right direction, the carriage 30 moves in the left direction or the right direction along the carriage guide 15 while being guided by the guide rails 17.

FIG. 4 will now be referred to mainly. The workpiece feeder 200 includes a feed roller 21 that unwinds the workpiece W before printing, and a take-up roller 22 that winds the workpiece W after printing. The feed roller 21 is located in a lower rear portion of the apparatus frame 100. The feed roller 21 is a winding shaft of a feed roll WA as a wound roll of the workpiece W before printing. The take-up roller 22 is located in a lower front portion of the apparatus frame 100. The take-up roller 22 is a winding shaft of a take-up roll WB as a wound roll of the workpiece W after the printing process. The take-up roller 22 includes a first motor M1 that rotates the take-up roller 22 about its axis to wind the workpiece W.

A path extending through the printing area 12 between the feed roller 21 and the take-up roller 22 is a feed path of the workpiece W. This feed path includes, in the order from upstream, a first tension roller 23, a workpiece guide 24, a transport roller 25 and a pinch roller 26, a turn roller 27, and a second tension roller 28. The first tension roller 23 applies a predetermined tension to the workpiece W upstream from the transport roller 25. The workpiece guide 24 redirects the workpiece W from upward to frontward and feeds the workpiece W into the printing area 12.

The transport roller 25 generates a feed force for intermittently feeding the workpiece W in the printing area 12. The transport roller 25, which is driven by a second motor M2, rotates about its axis and intermittently feeds the workpiece W frontward (in the predetermined feed direction F) to allow the workpiece W to pass through the printing area 12 (image formation position) facing the carriage 30. The pinch roller 26 faces the transport roller 25 from above and forms a feed nip with the transport roller 25.

The turn roller 27 redirects the workpiece W that has passed through the printing area 12 from frontward to downward, and guides the workpiece W to the take-up roller 22 after the printing process. The second tension roller 28 applies a predetermined tension to the workpiece W downstream from the transport roller 25. A platen 29 is located below the feed path of the workpiece W in the printing area 12.

The carriage 30 reciprocates, while being held by the guide rails 17 in a cantilevered manner, in the main scanning direction S (the lateral direction in FIGS. 3 and 4) intersecting with (perpendicular to in FIGS. 3 and 4) the feed direction F. The carriage 30 includes a carriage frame 30A as well as the ink heads 4, the pretreatment liquid head 5, the post-treatment liquid head 6, and the subtanks 70 mounted on the carriage frame 30A (refer to FIG. 3). The carriage frame 30A includes a head support frame 31 and a back frame 32.

The head support frame 31 is a horizontal plate holding the ink heads 4, the pretreatment liquid head 5, and the post-treatment liquid head 6 described above. The back frame 32 is a vertical plate extending upward from a rear edge of the head support frame 31. As described above, the timing belt 16 is fixed to the back frame 32. The guide rails 17 are engaged with the back frame 32. In other words, the back frame 32 is an engaging portion held by the guide rails 17 in a cantilevered manner in the example in FIG. 4. The head support frame 31 is a horizontal plate including a rear end portion held by the guide rails 17 in a cantilevered manner with the engaging portion.

Note that being held in a cantilevered manner refers to a state in which the engaging portion (back frame 32) in the carriage 30 held by the guide rails 17 as holding members is located either upstream or downstream from the middle of the carriage 30 in the feed direction F, with no other engaging portion in an area opposite to the area including the engaging portion. The engaging portion may also be located outside an area including the ink heads 4 and the treatment heads in the feed direction F. In other words, the engaging portion may be located either upstream or downstream from the area including the ink heads 4, the pretreatment liquid head 5, and the post-treatment liquid head 6 in the feed direction F.

The carriage 30 will be described further. FIG. 5 is an enlarged perspective view of the carriage illustrated in FIG. 3. FIG. 5 illustrates the feed direction F (subscanning direction) of the workpiece W and the main scanning direction S in which the carriage 30 moves. In the example illustrated in FIG. 5, the carriage 30 carries multiple ink heads 4 that eject ink onto the workpiece W for image formation, the pretreatment liquid head 5 and the post-treatment liquid head 6 that eject noncolor-developing treatment liquids, and multiple subtanks 70 that supply the ink, the pretreatment liquid, and the post-treatment liquid to the ink heads 4, the pretreatment liquid head 5, and the post-treatment liquid head 6.

Each of the ink heads 4 includes many nozzles (ink ejection orifices) and an ink channel that guides ink to the nozzles. The nozzles eject ink droplets by, for example, piezoelectric ejection using piezoelectric elements or thermal ejection using heating elements. The ink may be, for example, the ink described in detail above. In the example illustrated in FIG. 5, the multiple ink heads 4 can respectively eject eight colors of ink. The ink heads 4 are mounted on the head support frame 31 in the carriage 30 in two arrays in the main scanning direction S. Two ink heads 4 are allocated for each color.

In the example in FIG. 5, the ink heads 4 include a first upstream ink head 41A and a first downstream ink head 41B. These ink heads 4 eject, for example, yellow ink. The ink heads 4 also include a second upstream ink head 42A and a second downstream ink head 42B. These ink heads 4 eject, for example, magenta ink. In the same or a similar manner, two ink heads 4 that eject the same color of ink are arranged in a manner displaced from each other in the feed direction F and the main scanning direction S as illustrated in FIG. 5. With these two ink heads 4 being paired, a total of eight pairs of ink heads 4 (41A to 48A and 41B to 48B) eject different colors of ink.

The pretreatment liquid head 5 and the post-treatment liquid head 6 are displaced from the ink heads 4 in the feed direction F. The pretreatment liquid head 5 is upstream from the ink heads 4 in the feed direction F. In the example illustrated in FIG. 5, a single pretreatment liquid head 5 is located adjacent to the left end of the arrays of the ink heads 4. In the same or a similar manner, the post-treatment liquid head 6 is downstream from the ink heads 4 in the feed direction F. In the example illustrated in FIG. 5, a single post-treatment liquid head 6 is located at the right end of the arrays of the ink heads 4. In another embodiment, multiple pretreatment liquid heads 5 or multiple post-treatment liquid heads 6 may be arranged.

Note that a series of heads including the ink heads 4, the pretreatment liquid head 5, and the post-treatment liquid head 6 arranged in the main scanning direction S is referred to as an array of heads, or simply an array. A series of heads including the ink heads 4, the pretreatment liquid head 5, and the post-treatment liquid head 6 arranged in the feed direction F is referred to as a line of heads, or simply a line.

The pretreatment liquid head 5 ejects a pretreatment liquid for a predetermined pretreatment onto the workpiece W. The pretreatment liquid is ejected from the pretreatment liquid head 5 onto an area of the workpiece W on which no ink has been ejected from the ink heads 4. The pretreatment liquid may be the pretreatment liquid described above.

The post-treatment liquid head 6 ejects a post-treatment liquid for a predetermined post-treatment onto the workpiece W on which ink has been deposited. The post-treatment liquid is ejected from the post-treatment liquid head 6 onto an area of the workpiece W on which ink has been ejected from the ink heads 4. The post-treatment liquid may be the post-treatment liquid described above. In the present embodiment, the printed textile is produced by appropriately adjusting the ejected amount of the post-treatment liquid (the amount of the post-treatment liquid ejected per cycle and in total) to obtain the permeation gradient indicating that the amount of the silicone component decreases from the front surface toward the rear surface of the printed textile, as described above.

In the example illustrated in FIGS. 3 to 5, the pretreatment liquid, the ink, and the post-treatment liquid are ejected in this order onto an area of the workpiece W on which colors are to be printed based on an image. In this case, the ink may have one color or multiple colors. For an area on which no color is printed, or in other words, an area on which no ink is ejected, no pretreatment liquid or no post-treatment liquid is basically ejected.

As illustrated in FIG. 5, the head support frame 31 includes openings 31H at positions of the heads. The head support frame 31 receives the ink heads 4, the pretreatment liquid head 5, and the post-treatment liquid head 6 fitted into the respective openings 31H. The nozzles on the lower end face of the heads (the ink heads 4, the pretreatment liquid head 5, and the post-treatment liquid head 6) are exposed through the respective openings 31H.

The multiple subtanks 70 are supported by, with a holding frame (not illustrated), the carriage 30 above each of the heads (the ink heads 4, the pretreatment liquid head 5, and the post-treatment liquid head 6). Each of the multiple subtanks 70 is located to correspond to one of the ink heads 4, the pretreatment liquid head 5, or the post-treatment liquid head 6. Each of the subtanks 70 receives the ink or the treatment liquid from a main tank 90 storing the ink or the treatment liquid, and supplies the ink or the treatment liquid to the corresponding head. Each of the subtanks 70 is connected to the corresponding head with a pipe (not illustrated).

In the example illustrated in FIG. 5, the multiple subtanks 70 include, in a rear area, a first supply subtank 71A to an eighth supply subtank 78A, a pretreatment supply subtank 7FA, and a post-treatment supply subtank 7RA arranged in the main scanning direction S. The multiple subtanks 70 also include, in a front area, a first collection subtank 71B to an eighth collection subtank 78B, a pretreatment collection subtank 7FB, and a post-treatment collection subtank 7RB arranged in the main scanning direction S.

In the example illustrated in FIG. 5, the first supply subtank 71A and the first collection subtank 71B located leftmost in the carriage 30 store, for example, yellow ink containing a pigment. In this case, the first supply subtank 71A supplies the yellow ink to the first upstream ink head 41A and the first downstream ink head 41B (each referred to as a supply destination). The first collection subtank 71B stores the yellow ink collected from the first upstream ink head 41A and the first downstream ink head 41B. Note that part of the yellow ink is ejected from the first upstream ink head 41A and the first downstream ink head 41B onto the workpiece W as described above. In the same or a similar manner, the second supply subtank 72A supplies, for example, magenta ink to the second upstream ink head 42A and the second downstream ink head 42B. The second collection subtank 72B stores the magenta ink collected from the second upstream ink head 42A and the second downstream ink head 42B. The third to eighth subtanks also have the same structure and functions as or similar structure and functions to the subtanks described above.

The pretreatment supply subtank 7FA supplies the pretreatment liquid to the pretreatment liquid head 5, and the pretreatment collection subtank 7FB collects the pretreatment liquid from the pretreatment liquid head 5. The post-treatment supply subtank 7RA supplies the post-treatment liquid to the post-treatment liquid head 6, and the post-treatment collection subtank 7RB collects the post-treatment liquid from the post-treatment liquid head 6.

As described above, the inkjet printer 1000 illustrated in FIGS. 3 to 5 is an all-in-one printer including three types of heads, or the ink heads 4, the pretreatment liquid head 5, and the post-treatment liquid head 6, mounted on the single carriage 30. The inkjet printer 1000 can integrally perform the pretreatment liquid ejection and the post-treatment liquid ejection in an inkjet textile printing process of, for example, digital textile printing. This can simplify the textile printing process and reduce the size of the textile printing apparatus, for example.

Note that the inkjet printer 1000 illustrated in FIGS. 3 to 5 performs the printing process on the workpiece W by serial printing. More specifically, for a wide workpiece W, the workpiece W cannot typically undergo printing while being fed continuously. With serial printing, the carriage 30 carrying the ink heads 4 for the respective colors repeatedly reciprocates in the main scanning direction S while the workpiece W is being intermittently fed in the feed direction F.

Serial printing will now be described in detail. In the inkjet printer 1000 illustrated in FIGS. 3 to 5, the carriage 30 moving in an outgoing direction, which is one of the directions along the main scanning direction S, prints a strip image. During the main scanning in the outgoing direction, the feed of the workpiece W is stopped. The workpiece W on which the strip image has been printed is then fed forward in the feed direction F by a predetermined pitch. During the feed, the carriage 30 stays in the turn-back area 14 at the left end. After the workpiece W is fed forward, the carriage 30 turns back in a return direction opposite to the outgoing direction, as the timing belt 16 rotates in the reverse direction. During this time, the workpiece W is stationary. The carriage 30 then moves in the return direction and prints a subsequent strip image upstream from the strip image that has been printed in the movement in the outgoing direction. The same or a similar movement is repeated subsequently.

### Overview of Present Disclosure

In a first aspect of the present disclosure, a printed textile includes a printing substrate and a treatment agent deposited on the printing substrate. The treatment agent contains a pigment, binder resin particles, and a silicone component. The silicone component is on a front surface and a rear surface of the printed textile. An amount of the silicone component on the rear surface is smaller than an amount of the silicone component on the front surface.

This printed textile has intended texture and rubbing fastness.

In a second aspect of the present disclosure, a printed textile is the printed textile according to the first aspect in which the amount of the silicone component on the rear surface is less than or equal to 70% of the amount of the silicone component on the front surface.

The printed textile with this structure can have more intended rubbing fastness, or specifically, more intended wet rubbing fastness.

In a third aspect of the present disclosure, a printed textile is the printed textile according to the second aspect in which the amount of the silicone component on the rear surface is greater than 15% of the amount of the silicone component on the front surface.

The printed textile with this structure can have intended texture reliably.

In a fourth aspect of the present disclosure, a printed textile is the printed textile according to the third aspect in which the amount of the silicone component on the rear surface is greater than or equal to 31% of the amount of the silicone component on the front surface.

The printed textile with this structure can have intended texture more reliably.

In a fifth aspect of the present disclosure, a printed textile is the printed textile according to the fourth aspect in which the amount of the silicone component on the rear surface is 46 to 60% inclusive of the amount of the silicone component on the front surface.

The printed textile with this structure can have intended texture and rubbing fastness (particularly, wet rubbing fastness) more reliably.

In a sixth aspect of the present disclosure, a printed textile is the printed textile according to any one of the first to fifth aspects in which the pigment is on the front surface of the printed textile and in an inner layer portion of the printed textile between the front surface and the rear surface.

The printed textile with this structure can have images with vibrant colors.

In a seventh aspect of the present disclosure, a printed textile is the printed textile according to any one of the first to sixth aspects in which the rear surface of the printed textile is free of the pigment.

The printed textile with this structure can have images with more vibrant colors. Further, the rear portion of the printed textile is expected to have more intended texture.

In an eighth aspect of the present disclosure, a printed textile is the printed textile according to any one of the first to seventh aspects in which the printing substrate is polyester fabric.

The printed textile with this structure is expected to have intended texture and rubbing fastness more reliably.

In a ninth aspect of the present disclosure, a printed textile is the printed textile according to any one of the first to eighth aspects in which the printed textile is an inkjet-printed textile.

The printed textile with this structure can easily have intended texture and rubbing fastness.

### WORKING EXAMPLES

Although working examples of the present disclosure will be described in detail below, the embodiments are not limited to these working examples.

In the working examples, various printed textiles for evaluation were produced by changing the ratio of the Si detection amount on the rear surface to the Si detection amount on the front surface of the printed textile. The texture and the rubbing fastness of each of the printed textiles produced for evaluation were evaluated. In addition, the cross section of each of the printed textiles produced for evaluation was observed to identify the pigmented portions. The color development in each of the printed textiles produced for evaluation was also evaluated.

### 1. Method for Producing Printed Textiles for Evaluation

Printed textiles for evaluation were produced with the methods described below in the working examples and comparative examples.

### Working Example 1

The printed textile for evaluation in working example 1 was prepared by causing an inkjet printer to eject a pretreatment liquid, ink (black), and a post-treatment liquid in this order onto polyester tropical fabric as a printing substrate. The method for preparing the pretreatment liquid, the ink, and the post-treatment liquid, and the method in producing the printed textile for evaluation in working example 1 using these liquids will now be described.

### Method for Preparing Pretreatment Liquid

A modified cationic polymer solution to be contained in the pretreatment liquid was first prepared. A column was filled with 0.5 L of a strongly basic ion-exchange resin (OH form), and 1 L of “PAS-A-5” (manufactured by Nittobo Medical Co., Ltd.) was passed through the column at a flow velocity of 50 mL/min to obtain the modified cationic polymer solution. “PAS-A-5” is a cationic polymer of quaternary ammonium salts (copolymer of diallyldimethylammoniumchloride and sulfur dioxide). The solid content of the obtained modified cationic polymer solution was 40%.

Subsequently, 3 parts by mass (solid content) of the modified cationic polymer solution prepared above, 2 parts by mass of succinic acid, 1 part by mass of a nonionic surfactant (Surfynol 440 manufactured by Nissin Chemical Industry Co., Ltd.), 10 parts by mass of propylene glycol, and water added to a total of 100 parts by mass were mixed. The mixture was then filtered using a 5 μm-filter to obtain the pretreatment liquid (pH 8.0, chloride ion concentration 4.5 g/L).

### Method for Preparing Ink (Black)

In a 1-L three-necked flask with a stirring blade, 125 g of ion exchange water and 2 g of a nonionic surfactant (Surfynol 440 (registered trademark) manufactured by Nissin Chemical Industry Co., Ltd., which is an ethylene oxide adduct of acetylene glycol) were placed. While the contents of the flask were stirred, 165 g of propylene glycol, 100 g of black pigment dispersion (“AE2078F” manufactured by Sanyo Color Works, Ltd., substance: C.I. Pigment Black 7, solid concentration: 20 mass %), and 108 g of a binder resin particle dispersion (“Superflex 470” manufactured by DKS Co. Ltd., substance: polyurethane dispersion, solid concentration: 38 mass %) were added in this order to the flask. The flask contents were stirred for an additional 10 minutes to obtain ink (black).

### Method for Preparing Post-Treatment Liquid

A silicone emulsion to be contained in a post-treatment liquid was first prepared. More specifically, 300 g of amino-modified silicone oil (KF-864 manufactured by Shin-Etsu Chemical Co., Ltd., viscosity: 1700 mm²/s, specific gravity: 0.98 (25 °C), functional group equivalent weight: 3800 g/mol), 600 g of ion exchange water, and 100 g of a hydrochloric acid solution (concentration: 1 mol/L) were placed in a beaker. The contents of the beaker were stirred using a homogenizer (Ultra-Turrax T25 manufactured by IKA) at a rotational speed of 10000 rpm for 15 minutes and were left at rest for 30 minutes. The contents of the beaker were then filtered through a 120-mesh stainless steel filter to obtain a silicone emulsion.

The post-treatment liquid was then prepared using the silicone emulsion prepared in the manner described above. More specifically, 30 g of the above silicone emulsion, 35 g of ion exchange water, and 35 g of propylene glycol were mixed to obtain the post-treatment liquid.

### Method for Producing Printed Textile for Evaluation in Working Example 1

Polyester tropical fabric (manufactured by Shikisensha Co., Ltd., warp: 150 denier, 48 filaments, weft: 150 denier, 48 filaments, warp density: 76 threads/inch, weft density: 68 threads/inch, fabric weight of 120 g/m²) was used as a printing substrate. The printed textile for evaluation was produced using a flatbed printing jig including inkjet printheads (“KJ4B” manufactured by Kyocera Corporation) arranged in a feed direction. The pretreatment liquid prepared above was introduced into a first printhead. The ink (black) prepared above was introduced into a second head. The post-treatment liquid prepared above was introduced into a third printhead. Using the flatbed printing jig, 10 g/m² (in total) of the pretreatment liquid, 20 g/m² (in total) of the ink (black), and 5 g/m² (in total) of the post-treatment liquid were ejected from the respective heads onto the polyester tropical fabric. The heads ejected the ink in a droplet size of 18 pL per cycle and ejected the treatment liquids in a droplet size of 9 pl per cycle. The ink and the treatment liquids in the respective droplet sizes were ejected appropriate numbers of times based on the respective total ejected amounts. The ink and each of the treatment liquids were ejected at intervals of one second. The inkjet printing conditions included the distance between the fabric and the heads of 3 mm and the head temperature of 25 °C. The printing substrate was then heated in an oven at 160 °C for three minutes to dry the ink and the treatment liquids to obtain the printed textile for evaluation in working example 1.

### Working Example 2

The printed textile for evaluation in working example 2 was produced in the same manner as or a similar manner to the printed textile in working example 1 except that the ejected amount (total ejected amount) of the post-treatment liquid in producing the printed textile for evaluation was 20 g/m².

### Working Example 3

The printed textile for evaluation in working example 3 was produced in the same manner as or a similar manner to the printed textile in working example 1 except that the ejected amount (total ejected amount) of the post-treatment liquid in producing the printed textile for evaluation was 40 g/m².

### Working Example 4

The printed textile for evaluation in working example 4 was produced in the same manner as or a similar manner to the printed textile in working example 1 except that the printing substrate was replaced by cotton broadcloth fabric (manufactured by Shikisensha Co., Ltd., size: A4, cotton counts for warp and weft: 40/1, warp density: 130 threads/inch, weft density: 75 threads/inch, fabric weight: 122 g/m²).

### Working Example 5

The printed textile for evaluation in working example 5 was produced in the same manner as or a similar manner to the printed textile in working example 1 except that ink (yellow) prepared with the method described below was used in place of the ink (black).

### Method for Preparing Ink (Yellow)

In a 1-L three-necked flask with a stirring blade, 110 g of ion exchange water and 2 g of a nonionic surfactant (“Surfynol (registered trademark) 440” manufactured by Nissin Chemical Industry Co., Ltd., substance: ethylene oxide adduct of acetylene glycol) were placed. While the contents of the flask were stirred, 163 g of propylene glycol, 100 g of yellow pigment dispersion (“AE2032F” manufactured by Sanyo Color Works, Ltd., substance: C.I. Pigment Yellow 74, solid concentration: 20 mass %), and 125 g of a binder resin particle dispersion (“Superflex 420” from DKS Co. Ltd., substance: polyurethane dispersion, solid concentration: 32 mass %) were added in this order to the flask. The contents of the flask were stirred for an additional 10 minutes to obtain the ink (yellow).

### Working Example 6

The printed textile for evaluation in working example 6 was produced in the same manner as or a similar manner to the printed textile in working example 1 except that an delivered amount (total delivered amount) of 10 g/m² of the post-treatment liquid was sprayed onto the printing substrate in the production of the printed textile for evaluation.

### Working Example 7

The printed textile for evaluation in working example 7 was produced in the same manner as or a similar manner to the printed textile in working example 1 except that ink (cyan) prepared with the method described below was used in place of the ink (black).

### Method for Preparing Ink (Cyan)

In a 1-L three-necked flask with a stirring blade, 110 g of ion exchange water and 2 g of a nonionic surfactant (“Surfynol (registered trademark) 440” manufactured by Nissin Chemical Industry Co., Ltd., substance: ethylene oxide adduct of acetylene glycol) were placed. While the contents of the flask were stirred, 163 g of propylene glycol, 100 g of blue pigment dispersion (“BA2447F” manufactured by Sanyo Color Works, Ltd., substance: C.I. Pigment Blue 15, solid concentration: 20 mass %), and 125 g of a binder resin particle dispersion (“Superflex 420” manufactured by DKS Co. Ltd., substance: polyurethane dispersion, solid concentration: 32 mass %) were added in this order to the flask. The contents of the flask were stirred for an additional 10 minutes to obtain the ink (cyan).

### Working Example 8

The printed textile for evaluation in working example 8 was produced in the same manner as or a similar manner to the printed textile in working example 1 except that ink (magenta) prepared with the method described below was used in place of the ink (black).

### Method for Preparing Ink (Magenta)

In a 1-L three-necked flask with a stirring blade, 110 g of ion exchange water and 2 g of a nonionic surfactant (“Surfynol (registered trademark) 440” manufactured by Nissin Chemical Industry Co., Ltd., substance: ethylene oxide adduct of acetylene glycol) were placed. While the contents of the flask were stirred, 163 g of propylene glycol, 100 g of red pigment dispersion (“AG2172F” manufactured by Sanyo Color Works, Ltd., substance: C.I. Pigment Red 122, solid concentration: 20 mass %), and 125 g of a binder resin particle dispersion (“Superflex 420” from DKS Co. Ltd., substance: polyurethane dispersion, solid concentration: 32 mass %) were added in this order to the flask. The contents of the flask were stirred for an additional 10 minutes to obtain the ink (magenta).

### Working Example 9

The printed textile for evaluation in working example 9 was produced in the same manner as or a similar manner to the printed textile in working example 1 except that the ejected amount (total ejected amount) of the ink (black) for producing the printed textile was 10 g/m².

### Working Example 10

The printed textile for evaluation in working example 10 was produced in the same manner as or a similar manner to the printed textile in working example 1 except that the ejected amount (total ejected amount) of the post-treatment liquid for producing the printed textile was 10 g/m².

### Working Example 11

The printed textile for evaluation in working example 11 was produced in the same manner as or a similar manner to the printed textile in working example 1 except that polyester satin fabric (Shiny Stretch Satin manufactured by Uni Textile Co., Ltd., measured warp density: about 100 threads/inch, measured weft density: about 80 threads/inch, measured fabric weight: about 100 g/m²) was used as a printing substrate and that the ejected amounts (total ejected amounts) of the ink (black) and the post-treatment liquid were 40 g/m² and 10 g/m², respectively.

### Working Example 12

The printed textile for evaluation in working example 12 was produced in the same manner as or a similar manner to the printed textile in working example 1 except that nylon taffeta fabric (R5050 manufactured by Uni Textile Co., Ltd., measured warp density: about 100 threads/inch, measured weft density: about 80 threads/inch, measured fabric weight: about 70 g/m²) was used as a printing substrate.

### Working Example 13

The printed textile for evaluation in working example 13 was produced in the same manner as or a similar manner to the printed textile in working example 1 except that acetate satin fabric (Acetate Satin Vintage Finish KKF2660 manufactured by Uni Textile Co., Ltd., measured warp density: about 100 threads/inch, measured weft density: about 80 threads/inch, measured fabric weight: about 120 g/m²) was used as a printing substrate.

### Working Example 14

The printed textile for evaluation in working example 14 was produced in the same manner as or a similar manner to the printed textile in working example 13 except that the ejected amounts (total ejected amounts) of the ink (black) and the post-treatment liquid were 40 g/m² and 10 g/m², respectively, in producing the printed textile for evaluation.

### Working Example 15

The printed textile for evaluation in working example 15 was produced in the same manner as or a similar manner to the printed textile in working example 1 except that rayon staple fiber muslin fabric (manufactured by Shikisensha Co., Ltd., warp count: 40-1 strand, weft count: 40-1 strand, warp density: 87 threads/inch, weft density: 72 threads/inch, fabric weight: 99 g/m²) was used as a printing substrate.

### Working Example 16

The printed textile for evaluation in working example 16 was produced in the same manner as or a similar manner to the printed textile in working example 15 except that the ejected amounts (total ejected amounts) of the ink (black) and the post-treatment liquid were 40 g/m² and 10 g/m², respectively, in producing the printed textile for evaluation.

### Working Example 17

The printed textile for evaluation in working example 17 was produced in the same manner as or a similar manner to the printed textile in working example 1 except that Tencel lyocell satin fabric (TN8811 from Uni Textile Co., Ltd., warp count: 80-1 strand, weft count: 80-1 strand, warp density: 210 threads/inch, weft density: 120 threads/inch, measured fabric weight: about 100 g/m²) was used as a printing substrate.

### Working Example 18

The printed textile for evaluation in working example 18 was produced in the same manner as or a similar manner to the printed textile in working example 17 except that the ejected amounts (total ejected amounts) of the ink (black) and the post-treatment liquid were 40 g/m² and 10 g/m², respectively, in producing the printed textile for evaluation.

### Working Example 19

The printed textile for evaluation in working example 19 was produced in the same manner as or a similar manner to the printed textile in working example 4 except that the ejected amount (total ejected amount) of the ink (black) was 10 g/m² in producing the printed textile for evaluation.

### Working Example 20

The printed textile for evaluation in working example 20 was produced in the same manner as or a similar manner to the printed textile in working example 4 except that the ejected amount (total ejected amount) of the post-treatment liquid was 10 g/m² in producing the printed textile for evaluation.

### Working Example 21

The printed textile for evaluation in working example 21 was produced in the same manner as or a similar manner to the printed textile in working example 4 except that the ejected amounts (total ejected amounts) of the ink (black) and the post-treatment liquid were 40 g/m² and 10 g/m², respectively, in producing the printed textile for evaluation.

### Comparative Example 1

The printed textile for evaluation in comparative example 1 was produced in the same manner as or a similar manner to the printed textile in working example 1 except that the post-treatment liquid was not ejected or delivered in producing the printed textile for evaluation.

### Comparative Example 2

The printed textile for evaluation in comparative example 2 was produced in the same manner as or a similar manner to the printed textile in working example 1 except that 100 g/m² (in total) of the post-treatment liquid was delivered to the printing substrate by dip-coating in producing the printed textile for evaluation.

2. Measurement of Si Detection Amount (Mass %) with Quantitative Analysis Using EDX on Printed Textile for Evaluation in Working Examples and Comparative Examples

The amounts of the silicone component (Si detection amount) on the front surface and the rear surface of the printed textile were measured using printed textiles for evaluation each produced in the respective working examples and the respective comparative examples in the manner described above.

Measurement Method for Si Detection Amount (Mass %) with Quantitative Analysis Using EDX

The printed textile for evaluation produced in each of the working examples and the comparative examples was first cut into an appropriate size. On the cutout printed textile, Au—Pd was vapor-deposited at 10 mA for 60 seconds using Auto Fine Coater (“JEC-3000FC”, manufactured by JEOL Ltd.). Quantitative analysis was then performed using EDX with a scanning electron microscope (“JSM-IT500”, from JEOL Ltd.) at an accelerating voltage of 15 kV, a magnification of 200, and a WD of 10 mm. In the quantitative analysis using EDX, the Si detection amount was the amount in mass % of Si determined with the sum of the amounts of C, O, Si, and Au being 100 mass %. Note that the Si detection amount (mass %) was measured on the front surface and the rear surface of the printed textile for evaluation.

Table 1 below shows the Si detection amount on the front surface, the Si detection amount on the rear surface, and the ratio of the Si detection amount on the rear surface to the Si detection amount on the front surface, as well as the printing substrate, the ejected amount (total ejected amount) of the ink, the type of ink, the ejected amount (total ejected amount) or the delivered amount (total delivered amount) of the post-treatment liquid, and the treatment method for each of the printed textiles for evaluation in the corresponding working example or the corresponding comparative example. Note that the ratio of the Si detection amounts was rounded to one decimal place.

TABLE 1

| | | | | | | Result of analysis using EDX | | |
|---|---|---|---|---|---|---|---|---|
| | | | | Post-treatment liquid | | | | Ratio of Si |
| | | Ink | | Ejected or | | Si detection | Si detection | detection |
| | | Ejected | | delivered | | amount on | amount on | amount on rear |
| | Printing | amount | | amount | Treatment | front surface | rear surface | surface to front |
| | substrate | (g/m²) | Type | (g/m²) | method | (mass %) | (mass %) | surface (%) |
| Working example 1 | PET 1 | 20 | Black | 5 | IJ | 0.52 | 0.24 | 46 |
| Working example 2 | PET 1 | 20 | Black | 20 | IJ | 1.37 | 0.51 | 37 |
| Working example 3 | PET 1 | 20 | Black | 40 | IJ | 1.72 | 1.28 | 74 |
| Working example 4 | Cotton | 20 | Black | 5 | IJ | 0.45 | 0.12 | 27 |
| Working example 5 | PET 1 | 20 | Yellow | 5 | IJ | 0.42 | 0.25 | 60 |
| Working example 6 | PET 1 | 20 | Black | 10 | SP | 0.98 | 0.33 | 34 |
| Working example 7 | PET 1 | 20 | Cyan | 5 | IJ | 0.42 | 0.23 | 55 |
| Working example 8 | PET 1 | 20 | Magenta | 5 | IJ | 0.51 | 0.22 | 43 |
| Working example 9 | PET 1 | 10 | Black | 5 | IJ | 0.4 | 0.2 | 50 |
| Working example 10 | PET 1 | 20 | Black | 10 | IJ | 1.28 | 0.4 | 31 |
| Working example 11 | PET 2 | 40 | Black | 10 | IJ | 1.08 | 0.35 | 32 |
| Working example 12 | Ny | 20 | Black | 5 | IJ | 0.98 | 0.53 | 54 |
| Working example 13 | Acetate | 20 | Black | 5 | IJ | 0.44 | 0.18 | 41 |
| Working example 14 | Acetate | 40 | Black | 10 | IJ | 0.77 | 0.34 | 44 |
| Working example 15 | Rayon | 20 | Black | 5 | IJ | 0.63 | 0.21 | 33 |
| Working example 16 | Rayon | 40 | Black | 10 | IJ | 1.27 | 0.69 | 54 |
| Working example 17 | Lyocell | 20 | Black | 5 | IJ | 0.49 | 0.38 | 78 |
| Working example 18 | Lyocell | 40 | Black | 10 | IJ | 1.02 | 0.24 | 24 |
| Working example 19 | Cotton | 10 | Black | 5 | IJ | 0.4 | 0.12 | 30 |
| Working example 20 | Cotton | 20 | Black | 10 | IJ | 0.8 | 0.4 | 50 |
| Working example 21 | Cotton | 40 | Black | 10 | IJ | 1.68 | 0.25 | 15 |
| Comparative example 1 | PET 1 | 20 | Black | 0 | — | 0 | 0 | — |
| Comparative example 2 | PET 1 | 20 | Black | 100 | DP | 3.52 | 3.74 | 106 |

The terms in Table 1 have the following meanings. “PET 1” refers to polyester tropical fabric. “Cotton” refers to cotton broadcloth fabric. “PET 2” refers to polyester satin fabric. “Ny” refers to nylon taffeta fabric. “Acetate” refers to acetate satin fabric. “Rayon” refers to rayon staple fiber muslin fabric. “Lyocell” refers to Tencel lyocell satin fabric. For the treatment method with the post-treatment liquid, “IJ” refers to inkjet printing, “SP” refers to spraying, and “DP” refers to dip coating.

### 3. Evaluation of Printed Textile for Evaluation in Working Examples and Comparative Examples

The texture and the rubbing fastness of the printed textiles were evaluated using the printed textiles for evaluation each produced in the respective working examples and the respective comparative examples in the manners described above.

### Evaluation Method for Texture (Reduction of Deterioration in Fabric Hand)

An unused printing substrate was folded in two along the warp threads (in the length direction) and the distance between the lower and upper portion of the fabric at the fold (a loop height) was measured. The loop height of the unused printing substrate was measured as the loop height before textile printing. The produced printed textile for evaluation including an area with a solid-color image was then folded in two along the warp threads (in the length direction) to measure the loop height. The loop height of the printed textile for evaluation was measured as the loop height after textile printing. A change rate (in %) in the loop height before and after textile printing was calculated using the formula “change rate of loop height=100×loop height after textile printing/loop height before textile printing.” A lower change rate in the loop height indicates that the printing substrate does not harden or expand after textile printing, thus indicating less deterioration in fabric hand of the printed textile and intended texture of the printed textile. The texture of the printed textile (reduction of deterioration in fabric hand) was evaluated using the change rate in the loop height based on the criteria below. The evaluation A or A′ indicates a pass, and the evaluation B indicates a fail. Table 2 summarizes the change rates in the measured loop height and the evaluation results of the texture. Note that the different types of printing substrate differently deteriorate in fabric hand through textile printing. Thus, the evaluation criteria for the texture based on the change rate in the loop height are defined as described below.

### Evaluation Criteria for Texture

Evaluation A: The change rate in the loop height is less than 130%.
Evaluation A′: The change rate in the loop height is 130%.
Evaluation B: The change rate in the loop height is greater than 130%.

### Evaluation Method for Rubbing Fastness

A solid-color image formed on a printed textile for evaluation was rubbed with a white cotton rubbing cloth based on the dry test and the wet test using a rubbing tester type II (Gakushin test method) described in JIS L-0849:2013 (Test Methods for Color Fastness to Rubbing). The degree of staining on the white cotton rubbing cloth after rubbing was evaluated based on “Determination References for Discoloration and Color Fading” in section (Assessment of color fastness) of JIS L-0801:2011 (General Principles of Testing Methods for Color Fastness). The degree of staining on the white cotton rubbing cloth was categorized into nine levels (in descending order of staining degrees, level 1, level 1-2, level 2, level 2-3, level 3, level 3-4, level 4, level 4-5, and level 5). Lower levels of staining (closer to level 5) on the white cotton rubbing cloth indicate intended rubbing fastness. The degrees of staining on the white cotton rubbing cloth after the rubbing test were used in evaluating the dry rubbing fastness and the wet rubbing fastness based on the criteria below. Note that the dry test results were determined as dry rubbing fastness and the wet test results were determined as wet rubbing fastness. The evaluation results including no “B” for the dry rubbing fastness and the wet rubbing fastness indicated a pass. The evaluation results including at least one “B” for the dry rubbing fastness or the wet rubbing fastness indicated a fail. Table 2 summarizes the determined rubbing fastness and the evaluation results.

### Evaluation Criteria for Dry Rubbing Fastness

Evaluation A: The dry rubbing fastness is at level 3 or higher.
Evaluation B: The dry rubbing fastness is at a level lower than level 3.

### Evaluation Criteria for Wet Rubbing Fastness

Evaluation A: The wet rubbing fastness is at level 2 or higher.
Evaluation A′: The wet rubbing fastness is at level 1-2.
Evaluation B: The wet rubbing fastness is at a level lower than level 1-2.

TABLE 2

| | | | Rubbing fastness | | | |
|---|---|---|---|---|---|---|
| | Texture | | | | Wet | |
| | | Evaluation | Dry | | | Evaluation |
| | | (A: less | | Evaluation | | (A: level 2 |
| | | than 130, | | (A: level 3 | | or higher, |
| | Change rate | A′: 130, | | or higher, | | A′: level 1-2. |
| | in loop | B: greater | | B: lower than | | B: lower than |
| | height (%) | than 130) | Level | level 3) | Level | level 1-2) |
| Working example 1 | 105 | A | Level 4-5 | A | Level 2-3 | A |
| Working example 2 | 98 | A | Level 4 | A | Level 2-3 | A |
| Working example 3 | 95 | A | Level 3 | A | Level 1-2 | A′ |
| Working example 4 | 129 | A | Level 4-5 | A | Level 3 | A |
| Working example 5 | 106 | A | Level 4-5 | A | Level 2-3 | A |
| Working example 6 | 103 | A | Level 4 | A | Level 2-3 | A |
| Working example 7 | 104 | A | Level 4-5 | A | Level 2-3 | A |
| Working example 8 | 107 | A | Level 4-5 | A | Level 2-3 | A |
| Working example 9 | 101 | A | Level 4-5 | A | Level 3 | A |
| Working example 10 | 101 | A | Level 4 | A | Level 3 | A |
| Working example 11 | 128 | A | Level 4-5 | A | Level 3 | A |
| Working example 12 | 117 | A | Level 4 | A | Level 3 | A |
| Working example 13 | 121 | A | Level 4-5 | A | Level 3 | A |
| Working example 14 | 123 | A | Level 4-5 | A | Level 3 | A |
| Working example 15 | 108 | A | Level 4 | A | Level 2-3 | A |
| Working example 16 | 111 | A | Level 4 | A | Level 2-3 | A |
| Working example 17 | 115 | A | Level 4 | A | Level 1-2 | A |
| Working example 18 | 128 | A | Level 4 | A | Level 2 | A |
| Working example 19 | 124 | A | Level 4-5 | A | Level 3 | A |
| Working example 20 | 127 | A | Level 4-5 | A | Level 3 | A |
| Working example 21 | 130 | A′ | Level 4-5 | A | Level 2-3 | A |
| Comparative example 1 | 133 | B | Level 3-4 | A | Level 2 | A |
| Comparative example 2 | 90 | A | Level 2-3 | B | Level 1-2 | A′ |

### Discussion

First, Tables 1 and 2 show that the ratio of the Si detection amount on the rear surface to the Si detection amount on the front surface of the printed textile can change based on the factors such as the type of printing substrate, the ejected amount (total ejected amount) of the ink, and the type of ink, in addition to the factors such as the ejected amount (total ejected amount), the delivered amount (total delivered amount), and the applied amount (total applied amount) of the post-treatment liquid. For example, although the printed textile for evaluation in working example 4 was produced in the same manner as or a similar manner to the printed textile in working example 1 except that the printing substrate used was different, the ratio of the Si detection amount on the rear surface to the Si detection amount on the front surface of the printed textile was greatly different between these working examples. The above results also suggest that the ratio of the Si detection amount in each of the printing substrates changes based on, for example, the droplet size, the number of ejection cycles, and the ejection interval of the ink and the post-treatment liquid (or the pretreatment liquid, the ink, and the post-treatment liquid), and the specific method for ejecting, delivering, or applying these liquids. For example, the difference in the droplet size, the number of ejection cycles, and the ejection interval may have caused the different degrees of permeation of the liquids into the fabric in each type of printing substrate.

As shown in Tables 1 and 2, the Si detection amount on the rear surface of the printed textile for evaluation (the amount of the silicone component on the rear surface) was smaller than the Si detection amount on the front surface (the amount of the silicone component on the front surface) in working examples 1 to 21. These printed textiles had intended texture and rubbing fastness. In particular, the Si detection amount on the rear surface was less than or equal to 70% of the Si detection amount on the front surface of the printed textile for evaluation in working examples 1 to 2, 4 to 16, and 18 to 21. These printed textiles had more intended rubbing fastness, or more specifically, more intended wet rubbing fastness.

Further, when the Si detection amount on the rear surface was more than 15% of the Si detection amount on the front surface of the printed textile for evaluation, the printed textiles had more intended texture. When the Si detection amount on the rear surface was about 31 to 60% inclusive, or more specifically, about 46 to 60% inclusive of the Si detection amount on the front surface of the printed textile for evaluation, the printed textiles apparently tended to have substantially more intended texture and rubbing fastness (particularly, the wet rubbing fastness). However, the cotton broadcloth fabric and similar types of fabric easily deteriorate in fabric hand after textile printing, and had a slightly greater change rate in the loop height than other types of printing substrates.

The printed textile for evaluation in comparative example 1 was not treated with the post-treatment liquid and had markedly deteriorating texture. The printed textile for evaluation in comparative example 2 had deteriorating dry rubbing fastness. The amount of the silicone component on the rear surface being greater than that on the front surface may have caused the image formed on the front surface of the printed textile to have less friction resistance.

### 4. Identification of Pigmented Portion and Evaluation of Color Development in Printed Textiles for Evaluation in Working Examples

Pigmented portions of the printed textile for evaluation in working example 1 produced with the method described above were identified. The color development was then evaluated for the printed textiles for evaluation in working examples 1, 4, and 5 produced with the method described above.

### Method for Identifying Pigmented Portions and Identification Results

The pigmented portions were identified with the method described below. First, the surface of the printed textile for evaluation produced in working example 1 was fixed with Dunplon Tape No. 357-50™ manufactured by Nitto Denko Corporation and a 1-mm-cross-sectional sample of the image formation area was cut out with Hi-Stainless Double Edge Blade manufactured by Feather Safety Razor Co., Ltd. The cross-sectional sample of the cutout image formation area of the printed textile for evaluation was then visually observed with an optical microscope (“VHX-8000” manufactured by Keyence Corporation, magnification: 100). The pigment was identified on the front surface and the inner layer portion of the printed textile alone.

### Evaluation Method for Color Development

The color development was evaluated on the printed textiles for evaluation produced in working examples 1, 4, and 5. More specifically, the evaluation was performed by measuring the OD of the printed textiles for evaluation using a spectrodensitometer FD-5 (manufactured by Konica Minolta, Inc.). Evaluation criteria were as described below. Table 3 summarizes the evaluation results.
Evaluation A (intended color development): The OD is greater than or equal to 1.25.
Evaluation B (unintended color development): The OD is less than 1.25.

TABLE 3

| | | Ink | | Color development | |
|---|---|---|---|---|---|
| | | Ejected | | Optical | Evaluation |
| | Printing | amount | | density | (A: 1.25 or greater, |
| | substrate | (g/m²) | Type | (OD) | B: less than 1.25) |
| Working | PET 1 | 20 | Black | 1.28 | A |
| example 1 | | | | | |
| Working | Cotton | 20 | Black | 1.30 | A |
| example 4 | | | | | |
| Working | PET 1 | 20 | Yellow | 1.25 | A |
| example 5 | | | | | |

### Discussion

As shown in Table 3, the printed textile for evaluation in working example 1 had an OD of 1.28, with the evaluation result indicating intended color development. The result indicated that the image showed vibrant colors when the pigment was on the front surface and the inner layer portion of the printed textile alone. The printed textile for evaluation in working example 4, in which the printing substrate was a cotton broadcloth fabric, had an OD of 1.30, with the evaluation result indicating intended color development. The printed textile for evaluation in working example 5, in which yellow ink was used, had an OD of 1.25, with the evaluation result indicating intended color development.

The present application is based on Japanese Patent Application No. 2023-093424 filed on Jun. 6, 2023 and International Patent Application No. PCT/JP2023/046879 filed on Dec. 27, 2023, the contents of which are incorporated herein by reference.

The embodiments and working examples described herein are illustrative in all aspects and should not be construed to be restrictive. In other words, all changes at least within the meaning and range equivalency of the claims are within the range of the present disclosure. Although the comparative examples had unintended results in relative evaluation with respect to the working examples, the comparative examples are not to be construed as being disqualified or waived.

### INDUSTRIAL APPLICABILITY

In one or more embodiments of the present disclosure, the printed textile has intended texture and rubbing fastness.

### REFERENCE SIGNS

10 printed textile
10Sf front surface of printed textile
10Sb rear surface of printed textile
10M inner layer portion of printed textile
1 pigment
2 binder resin particle
3 silicone component
4 ink head
4a first ink head
4b second ink head
4c third ink head
4d fourth ink head
5 pretreatment liquid head
6 post-treatment liquid head
7 support
20 inkjet textile printing apparatus (partial)
P printing substrate
1000 inkjet printer
100 apparatus frame
111 center frame
112 right frame
113 left frame
12 printing area
13 maintenance area
14 turn-back area
15 carriage guide
16 timing belt
17 guide rail
200 workpiece feeder
21 feed roller
22 take-up roller
23 first tension roller
24 workpiece guide
25 transport roller
26 pinch roller
27 turn roller
28 second tension roller
29 platen
30 carriage
30A carriage frame
31 head support frame
31H opening
32 back frame
41A first upstream ink head
41B first downstream ink head
42A second upstream ink head
42B second downstream ink head
70 subtank
71A first supply subtank (supply tank)
71B first collection subtank (collection tank)
72A second supply subtank
72B second collection subtank
7FA pretreatment supply subtank
7FB pretreatment collection subtank
7RA post-treatment supply subtank
7RB post-treatment collection subtank

1. A printed textile, comprising:
a printing substrate; and
a treatment agent deposited on the printing substrate, the treatment agent containing a pigment, binder resin particles, and a silicone component,
wherein the silicone component is on a front surface and a rear surface of the printed textile, and
an amount of the silicone component on the rear surface is smaller than an amount of the silicone component on the front surface.

2. The printed textile according to claim 1, wherein
the amount of the silicone component on the rear surface is less than or equal to 70% of the amount of the silicone component on the front surface.

3. The printed textile according to claim 2, wherein
the amount of the silicone component on the rear surface is greater than 15% of the amount of the silicone component on the front surface.

4. The printed textile according to claim 3, wherein
the amount of the silicone component on the rear surface is greater than or equal to 31% of the amount of the silicone component on the front surface.

5. The printed textile according to claim 4, wherein
the amount of the silicone component on the rear surface is 46 to 60% inclusive of the amount of the silicone component on the front surface.

6. The printed textile according to claim 1, wherein
the pigment is on the front surface of the printed textile and in an inner layer portion of the printed textile between the front surface and the rear surface.

7. The printed textile according to claim 1, wherein
the rear surface of the printed textile is free of the pigment.

8. The printed textile according to claim 1, wherein
the printing substrate is polyester fabric.

9. The printed textile according to claim 1, wherein
the printed textile is an inkjet-printed textile.
